(19) United States
(12) Patent Application Publication
(10) Pub. No.: US 2003/0132638 A1
(43) Pub. Date: Jul. 17, 2003

(54) Wind-powered automobile

(76) Inventor: William Thomas Simonsen, Falls Church, VA (US)

Correspondence Address: William T. Simonsen, 3910 Whispering Lane, Falls Church, VA, 22041, US

(21) Appl. No.: 10/042,587

(22) Filed: Jan. 11, 2002

(51) Int. Cl. F03D 9/00; H02P 9/04

(52) U.S. Cl. 290/55

(57) ABSTRACT

The use of turbines turned by the wind that passes an automobile when it is running to electricity. This then runs the electric motor. This eliminates the combustion engine. Thus making it so that you never need to stop and get gasoline.

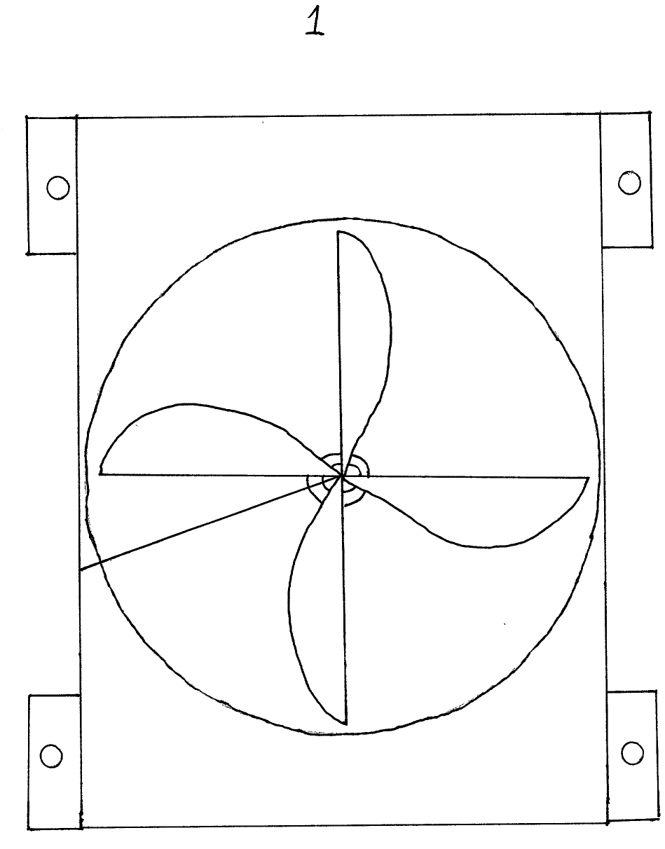

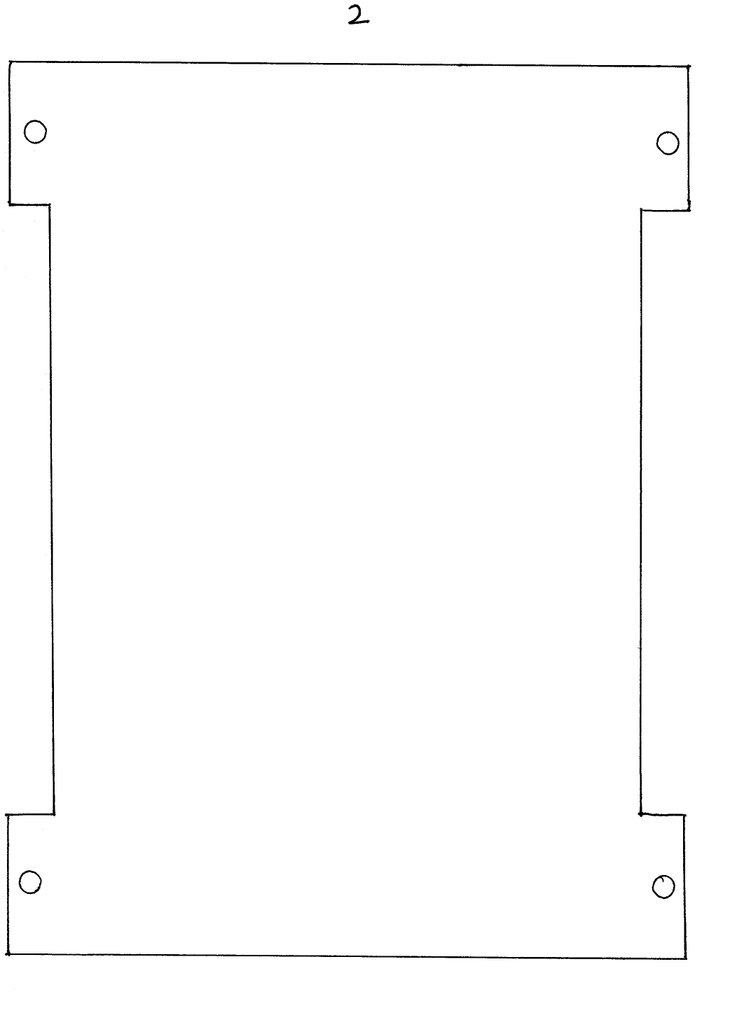

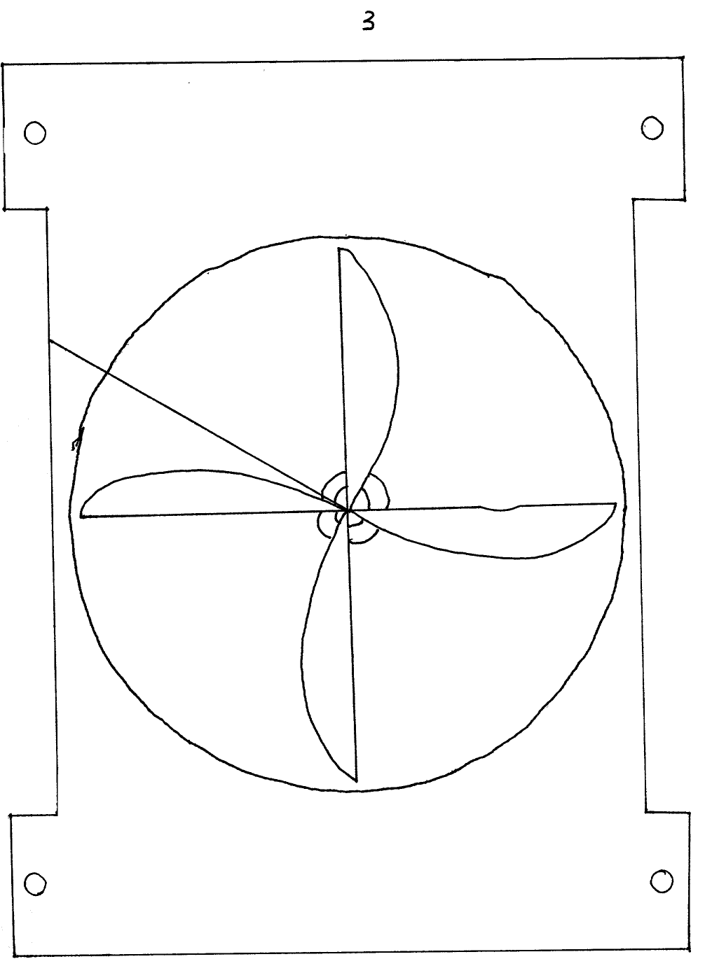

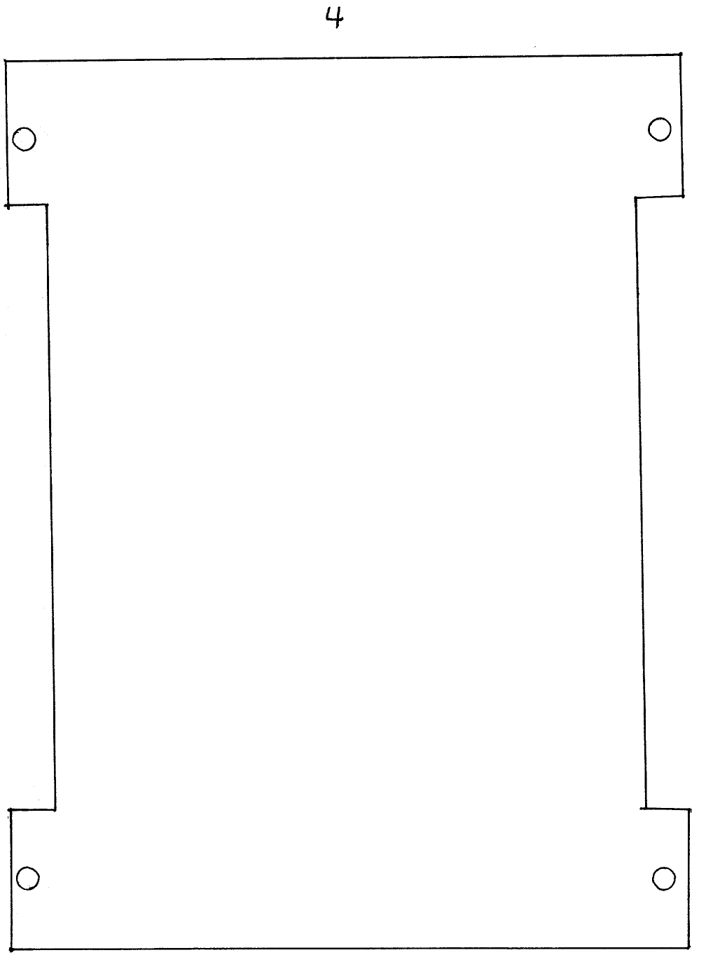

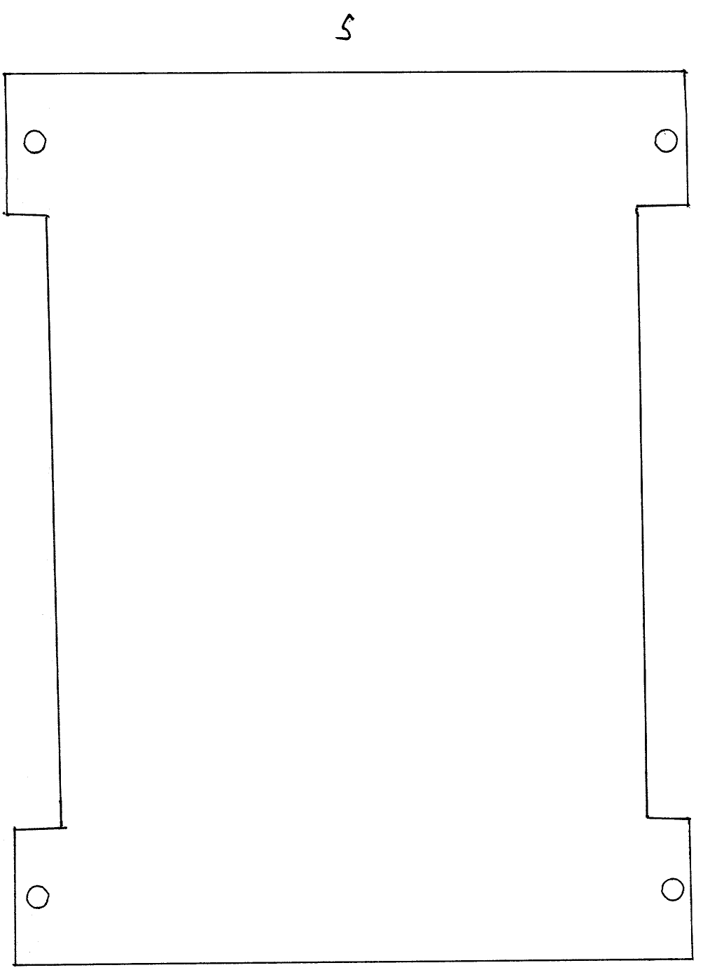

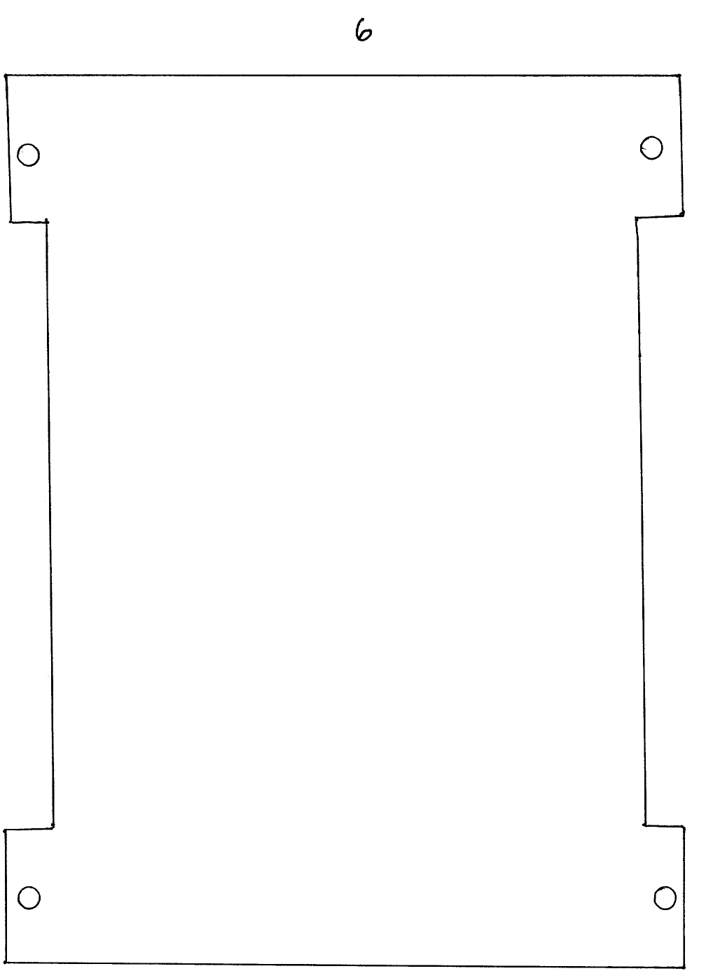

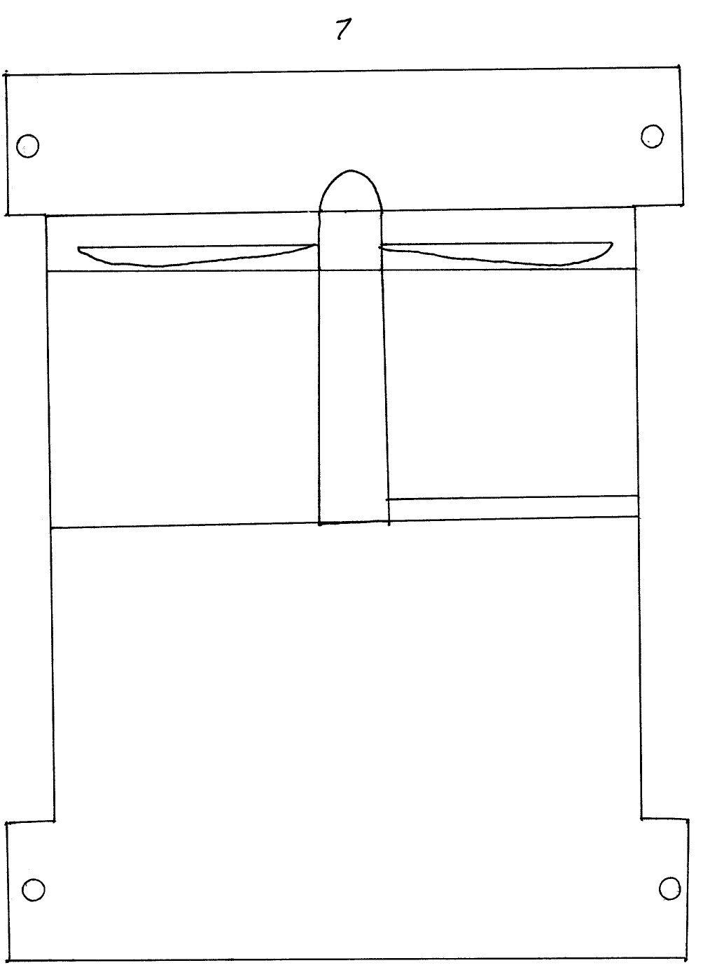

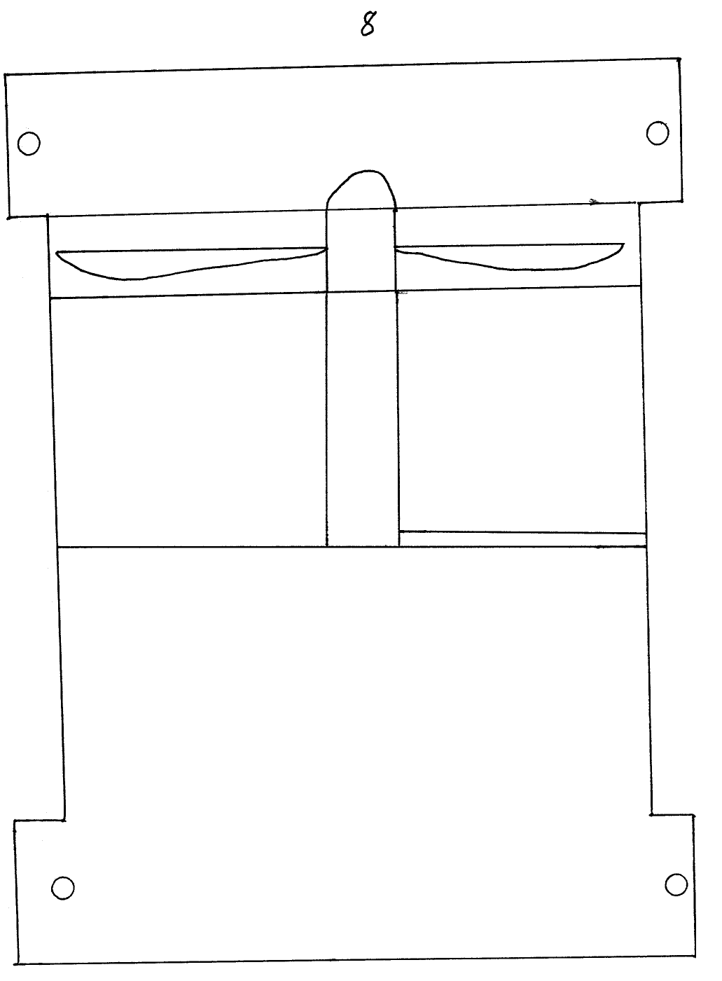

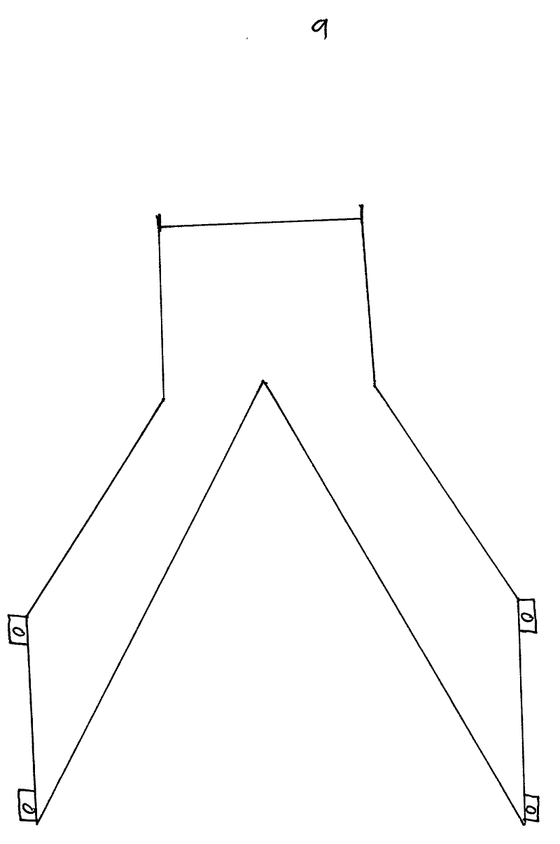

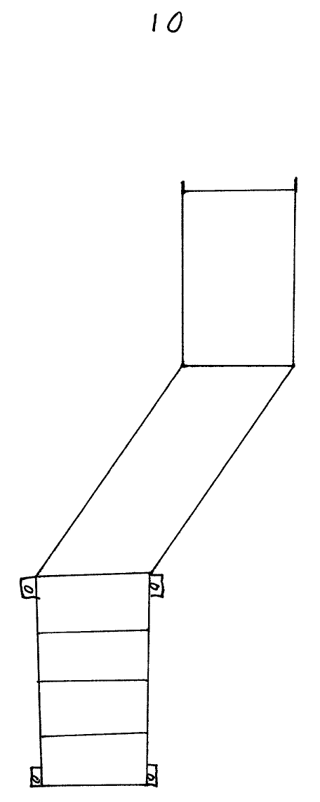

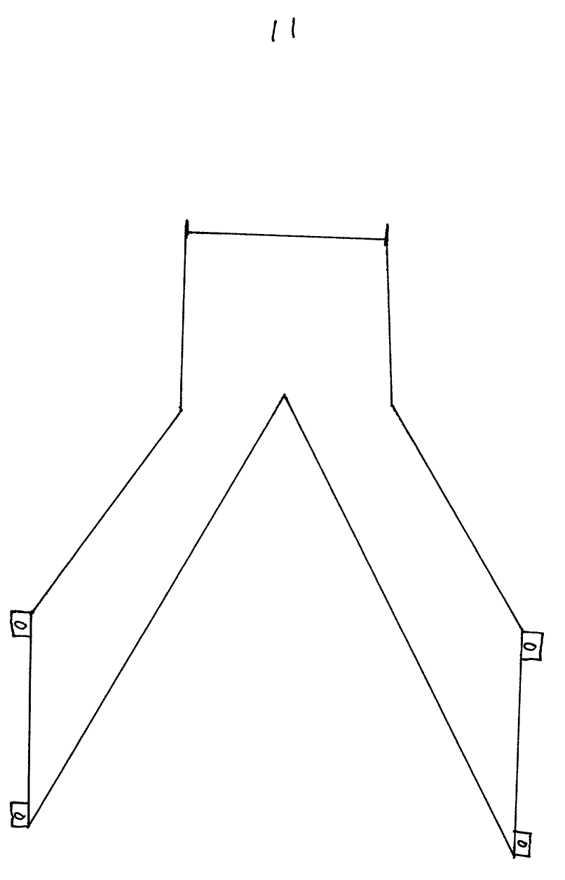

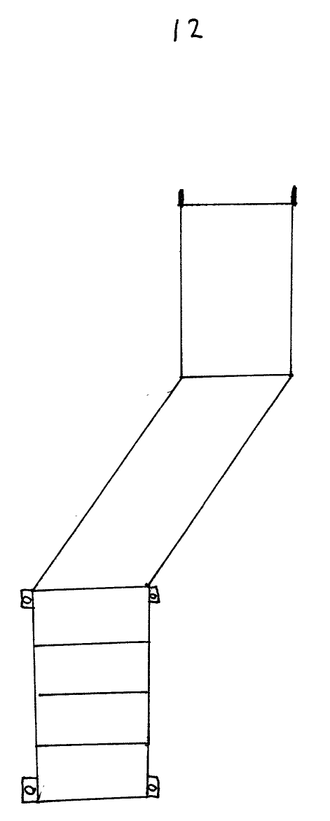

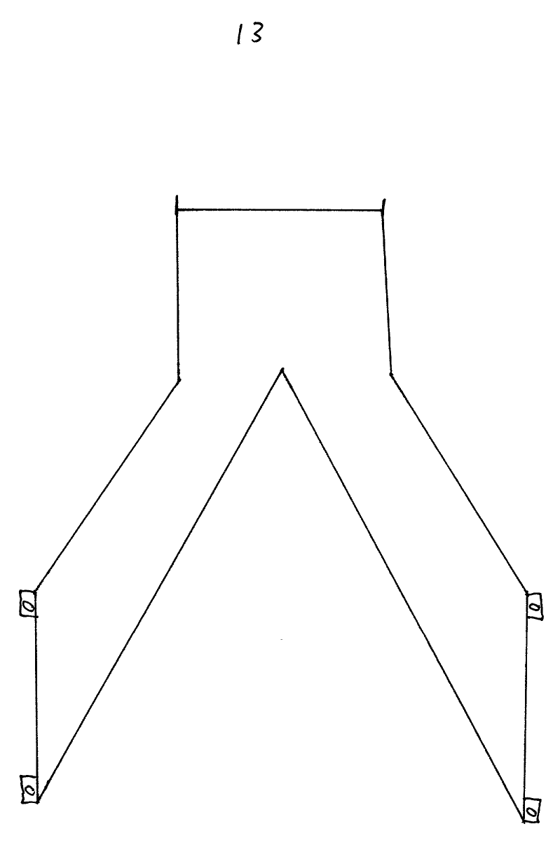

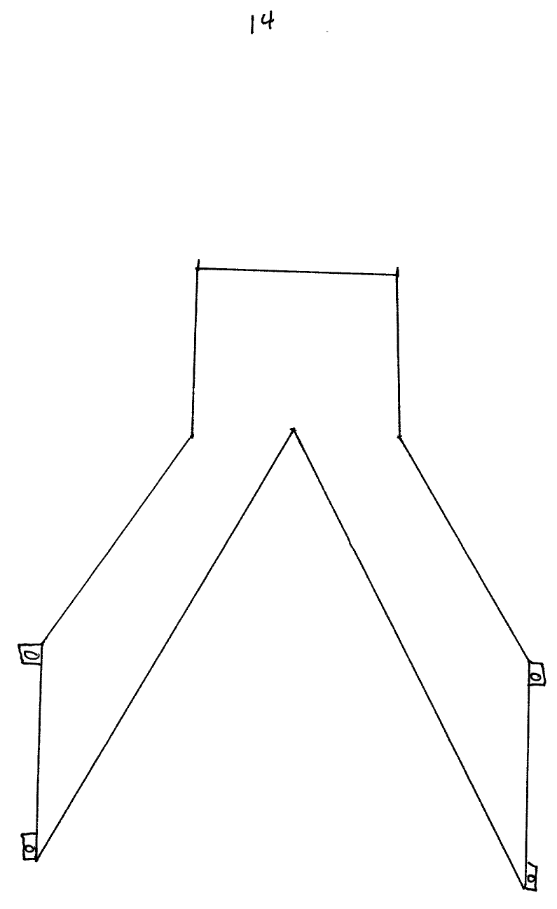

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The invention pertains to the power that propels an automobile. Alternatives engine that uses wind to turn turbines, which creates electricity. This then runs the electric motor.

The information known to me in the area of automotive engineering and turbine elements are the rate of power turned out by different turbines, and battery characteristics. This invention solves the problem of using an internal combustion engine to power an automobile. The invention does not need gasoline to propel the automobile; it uses the wind that passes it when driving to power it.

### BRIEF SUMMARY OF THE INVENTION

The invention takes the wind that passes by an automobile and turns it into power. The wind enters through the front of the automobile at the bumper. Wind goes into the grill into a set of wind tunnels that are inside the engine compartment. The wind is then directed to wind turbines. The circular turbines are set into the engine compartment facing forward. The circular turbines are in a casing, which is fastened to the frame. The wind passes into the turbines. The wind is then channeled into exits in the engine compartment. The exits are side events on the side of the car before the front doors.

The electricity that is gained by the turning of the turbines is sent to the circuit board. This then sends power to the engine. Electricity is sent to the motor to run it. All of the electricity is sent to the motor to reduce the amount of power needed by other sources.

### BRIEF DESCRIPTION OF THE SEVERAL VIEWS OF THE DRAWING

Illustration one is of the front view of the circular turbines casing. In the drawling there is the air inlet, and turbine blades. Illustration two is of the right side view of the circular turbines casing. In the drawling there is the clasps to secure the casing to the frame of the automobile. Illustration three is of the backside view of the circular turbines casing. In the drawling there is the air exit path. Also there are the power wires that go to the engine. Illustration four is of the left side view of the circular turbines casing. In the drawling there is clasps to secure casing to the frame of the automobile. Illustration five is of the topside view of the circular turbines casing. In the drawling there is the clasps to secure the casing to the frame of the automobile. Illustration six is of the bottom side of the circular turbines casing. In the drawling there is the bottom side of the casing, and the clasps to secure it to the frame of the automobile. Illustration seven is a top view of inside the casing of the circular turbines casing. In the drawling there is the turbine blades and motor, the air tunnels wiring, and the casing. Illustration eight is a bottom side view of inside the casing of the circular turbines casing. In the drawling there is the turbine blades and motor, the air tunnels wiring, and the casing.

Illustration nine is a topside view of the wind tunnel casing. In the drawling there is the topside of the casing, and the clasps to secure it to the frame of the automobile. Illustration 10 is a right side view of the wind tunnel casing. In the drawling there is the right side of the casing, and the clasps to secure it to the frame of the automobile. Illustration 11 is of the backside view of the wind tunnel casing. In the drawling there is the exit vents that go to the side of the automobile. Illustration 12 is a left side view of the wind tunnel casing. In the drawling there is the right side of the casing, and the clasps to secure it to the frame of the automobile. Illustration 13 is of the topside inside the casing view of the wind tunnel casing. In the drawling there is the plastic wind tunnel. Illustration 14 is a bottom side inside the casing view of the wind tunnel casing. In the drawling there is the plastic wind tunnel.

### DETAILED DESCRIPTION OF THE INVENTION

The wind comes into the engine compartment by the front vent; a coil, in certain conditions then heats the wind. A thermometer that tells when snow or ice is on turns on the coil. The wind is then sent to the turbines by a wind passage. The vent is made of aluminum, is made by casting. The coil is copper, and made by extrusion. The turbines are plastic, and are made by casting. The motor differs on the power needed by the automobile. Nevertheless, it is made by assembly process.

The circular wind turbine are set in a casing that has wind channeled to them from the front of an automobile. The turbines are set in a plastic casing that is cast/mold formed. Then that electricity is channeled to the motor. The casing is then bolted to the frame of the engine compartment. Connected by three-inch bolts on all four sides. The air outlet is connected to the back of the turbine casing by wing nuts and the air exit casing is connected to the side of the automobile frames by wing nuts on all four sides of the exit tube. The power goes through a negative and positive power line. That power comes off the backside of the turbine unit, through the side of the casing. The cable is enclosed in plastic and clipped to the side of the casing back to the motor. A thermometer that tells when snow or ice is on or in the turbine casing turns on the coil that heats grill. That stops snow and ice build up on the blades.

The electricity from the turbines is sent to the motor, which send it to the motor. The power is sent to the motor and automobile components (heater, air condition, radio, television, etc).

1. What I claim, as my invention is the use of wind that goes through air tunnels in the engine compartment that turns the wind turbines, which makes electricity. That then is to the motor of the automobile. This then turns the wheels.
